(19) United States
(12) Patent Application Publication
(10) Pub. No.: US 2024/0088490 A1
(43) Pub. Date: Mar. 14, 2024

(54) LAMINATE, INSULATING MATERIAL, AND BATTERY

(71) Applicant: UCHIYAMA MANUFACTURING CORP., Okayama-shi (JP)

(72) Inventors: Yohei SHIOMOTO, Akaiwa-shi (JP); Kazuhiro TAKAHASHI, Akaiwa-shi (JP)

(73) Assignee: UCHIYAMA MANUFACTURING CORP., Okayama-shi, Okayama (JP)

(21) Appl. No.: 18/242,687

(22) Filed: Sep. 6, 2023

(30) Foreign Application Priority Data
Sep. 9, 2022 (JP) 2022-144077

(51) Int. Cl. H01M 50/143; B05D 3/12; B05D 7/14

(52) U.S. Cl. CPC H01M 50/143; B05D 3/12; B05D 7/14; B05D 2530/00; B05D 2601/20

(57) ABSTRACT

Provided is a laminate that enables a further improvement in flame retardancy as compared with a conventional laminate. A laminate in accordance with the present disclosure includes: a metal plate; and a silicone rubber layer provided on a surface of the metal plate, the silicone rubber layer containing a flame retardant silicone rubber compound and a fiber-based flame retardant, and the flame retardant silicone rubber compound being rated as V-0 or higher according to UL94 standard.

This Nonprovisional application claims priority under 35 U.S.C. § 119 on Patent Application No. 2022-144077 filed in Japan on Sep. 9, 2022, the entire contents of which are hereby incorporated by reference.

### TECHNICAL FIELD

The present invention relates to a laminate, an insulating material, and a battery.

### BACKGROUND ART

Rubber coated metal obtained by forming a rubber layer on a surface of a metal plate is used for various purposes. For example, Patent Literature 1 discloses an internal combustion engine insulator including a metal plate and a silicone rubber or silicone resin layer provided on a surface of the metal plate.

### CITATION LIST

### Patent Literature

[Patent Literature 1]
Japanese Patent Application Publication, Tokukai, No. 2009-208009

### SUMMARY OF INVENTION

### Technical Problem

For example, members used in the battery field are sometimes required to have flame retardancy. It has become clear as a result of study by the inventors of the present invention that such a conventional technique as described above has room for further improvement in terms of flame retardancy.

An aspect of the present invention has an object to achieve a laminate that enables a further improvement in flame retardancy as compared with a conventional laminate.

### Solution to Problem

In order to attain the object, a laminate in accordance with an aspect of the present invention includes:
a metal plate; and
a silicone rubber layer provided on a surface of the metal plate,
the silicone rubber layer containing a flame retardant silicone rubber compound and a fiber-based flame retardant, and
the flame retardant silicone rubber compound being rated as V-0 or higher according to UL94 standard.

### Advantageous Effects of Invention

An aspect of the present invention provides a laminate that enables a further improvement in flame retardancy as compared with a conventional laminate.

### BRIEF DESCRIPTION OF DRAWINGS

FIG. 1 is a schematic view schematically illustrating a structure of a laminate in accordance with an embodiment of the present invention.

FIG. 2 is a schematic view schematically illustrating a structure of a battery in which an insulating material in accordance with an embodiment of the present invention is used.

FIG. 3 is a schematic view schematically illustrating a structure of a device for producing rubber coated metal in Examples.

FIG. 4 is a schematic view illustrating a process for producing rubber coated metal in Examples.

FIG. 5 is a schematic view illustrating a hot pressing process for obtaining a laminate in Examples.

FIG. 6 is a view illustrating evaluation results for Examples and Comparative Examples.

### DESCRIPTION OF EMBODIMENTS

The following description will discuss an embodiment of the present invention in detail. However, the present invention is not limited to the following embodiment, but can be altered in various ways within the description. An embodiment derived from an appropriate combination of technical means disclosed in different embodiments is also encompassed in the technical scope of the present invention. Any numerical range expressed as “A to B” herein means “not less than A and not more than B”.

[1. Laminate]

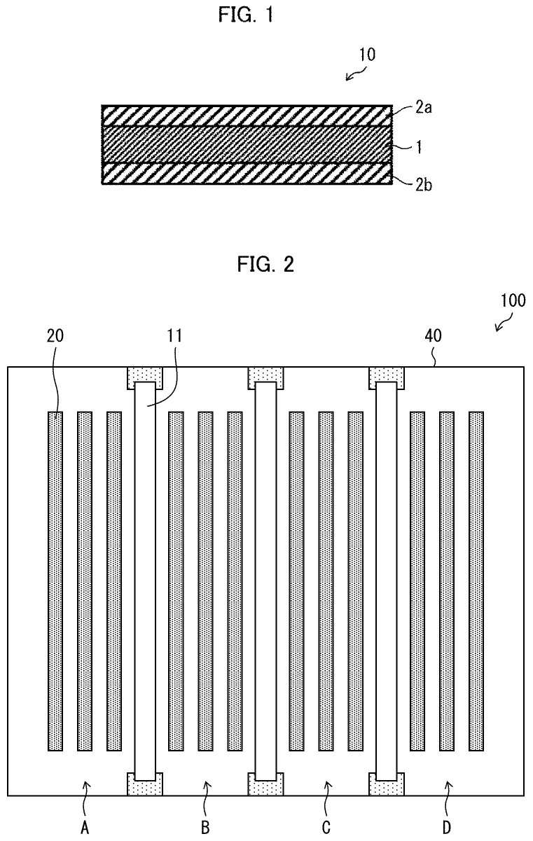

FIG. 1 is a schematic view schematically illustrating a structure of a laminate in accordance with an embodiment of the present invention. A laminate 10 includes a metal plate 1 and silicone rubber layers 2a and 2b provided on respective surfaces of the metal plate 1. FIG. 1 illustrates a laminate including a metal plate and a silicone rubber layer provided on both sides of the metal plate. Note, however, that the silicone rubber layer may be provided only on one side of the metal plate.

The laminate, which includes the metal plate, can maintain its shape. Furthermore, the laminate also functions as an insulating material because the silicone rubber layer is provided on at least one surface of the metal plate. Moreover, the silicone rubber layer, which contains a flame retardant silicone rubber compound and a fiber-based flame retardant, has both flame retardancy and an insulating property. Thus, use of the laminate as, for example, a separator (separate plate) of a battery makes it possible to (i) prevent spread of fire even in a case where a cell catches fire and (ii) maintain the insulating property even after burning.

[1.1. Metal Plate]

Examples of the metal plate include metal plates made of iron, aluminum, and the like, and plates of alloys of these metals. The metal plate may be subjected to a surface treatment such as plating. Specific examples of the metal plate include SECC shown in JIS (G3313), SUS301 shown in JIS (G4305), and SPCC shown in JIS (G3141).

In order to improve adhesion to the silicone rubber layer, an adhesive may be applied to the surface of the metal plate. Examples of the adhesive include a phenol-based adhesive, an epoxy-based adhesive, and a silane coupling agent.

The metal plate has a thickness that is preferably not less than 0.05 mm, and more preferably not less than 0.1 mm. The metal plate that has a thickness of not less than 0.05 mm is less likely to deform. In a case where a layer of a rubber solution (described later) is formed, the metal plate that has a thickness of not less than 0.05 mm is less likely to cause thickness unevenness in the layer of the rubber solution. Furthermore, the metal plate that has a thickness of not less than 0.05 mm is also preferable in terms of shape retainability of a resulting laminate. The metal plate has a thickness that is preferably not more than 3 mm, and more preferably not more than 2 mm. The metal plate that has a thickness of not more than 3 mm is less likely to cause warpage in the metal plate. In a case where a layer of a rubber solution is formed, the metal plate that has a thickness of not more than 3 mm is less likely to cause thickness unevenness in the layer of the rubber solution.

[1.2. Silicone Rubber Layer]

The silicone rubber layer contains the flame retardant silicone rubber compound and the fiber-based flame retardant. The silicone rubber layer is provided on at least one side of the metal plate, and preferably on both sides of the metal plate.

In order to ensure flame retardancy and the insulating property, the silicone rubber layer has a thickness per layer of preferably not less than 0.05 mm, and more preferably not less than 0.08 mm. In terms of productivity, the silicone rubber layer has a thickness per layer of preferably not more than 0.2 mm, and more preferably not more than 0.15 mm.

The flame retardant silicone rubber compound is a composition obtained by blending various additives with silicone rubber so as to impart flame retardancy to the silicone rubber. The flame retardant silicone rubber compound has flame retardancy that is rated as V-0 or higher according to UL94 standard.

The UL94 standard is a standard for evaluating flame retardancy of plastic products and is widely adopted worldwide. A rating of the UL94 standard includes 5VA, 5VB, V-0, V-1, V-2, and HB in decreasing order of flame retardancy. Thus, the flame retardant silicone rubber compound is rated as 5VA, 5VB, or V-0 according to the UL94 standard. In an embodiment, the flame retardant silicone rubber compound is rated as V-0 according to the UL94 standard. Since a UL94 standard test method is well known among persons skilled in the art, a description thereof is omitted.

Examples of the silicone rubber contained in the flame retardant silicone rubber compound include methyl silicone rubber, vinyl methyl silicone rubber, phenyl methyl silicone rubber, and silicone fluoride rubber. Only one of these silicone rubbers may be contained, or two or more of these silicone rubbers may be contained. In an embodiment, the flame retardant silicone rubber compound contains vinyl methyl silicone rubber. Examples of an additive contained in the flame retardant silicone rubber compound include platinum, platinum compounds, iron oxides, triazole-based compounds, and aluminum hydroxides. Only one of these additives may be contained, or two or more of these silicone rubbers may be contained. Many products of the flame retardant silicone rubber compound are commercially available, and there are many patent literatures related to the flame retardant silicone rubber compound. Thus, a description of a detailed composition of the flame retardant silicone rubber compound is omitted.

Examples of the flame retardant silicone rubber compounds that are commercially available include: SILASTIC (trademark (™)) SH502U, SH502U A/B, and SH1447 U A (each available from Dow Toray Co., Ltd.); KE-5620W-U, KE-5620BL-U, KE-5612E-U, KE-3494, KE3490, KE3467, KE-4890, KE-40RTV, KE-1831, KE-1867, KE-1891, KE-1204-LTV, KE-1292, KE-1800, and KE-1802 (each available from Shin-Etsu Chemical Co., Ltd.); ELASTOSIL® LR 3011/50 FR, LR 3001/55 FR, LR 3001/60 FR, and LR 3170/40 (each available from Wacker Asahikasei Silicone Co., Ltd); and TSE2186U, TSE2183U, TSE2187U, TSE2184U, TCM5406U, and XE20-A7016 (each available from Momentive Performance Materials Japan LLC).

Examples of a patent literature that discloses the flame retardant silicone rubber compound include Japanese Patent Application Publication, Tokukai, No. 2004-149693, Japanese Patent Application Publication, Tokukai, No. 2006-182911, and Japanese Patent Application Publication, Tokukai, No. 2009-144024.

The fiber-based flame retardant means a flame retardant that has a fibrous form. The expression “fibrous form” is herein intended to mean a shape having an aspect ratio (length/diameter) of not less than 3.

The inventors of the present invention have found that the silicone rubber layer obtained by combining the flame retardant silicone rubber compound and the fiber-based flame retardant has higher flame retardancy than the flame retardant silicone rubber compound itself. However, blending of a flame retardant (such as a particulate inorganic flame retardant) other than the fiber-based flame retardant exhibited no effect of improvement in flame retardancy (for details, see Examples of the present application). That is, it can be said that selection of the fiber-based flame retardant among flame retardants which have various types has led to exhibition of an effect of the present invention.

An average fiber length of the fiber-based flame retardant has a lower limit that is preferably not less than 50 μm, more preferably not less than 100 μm, and even more preferably not less than 150 μm. The average fiber length of the fiber-based flame retardant has an upper limit that is preferably not more than 750 μm, more preferably not more than 500 μm, and even more preferably not more than 250 μm. An average diameter of the fiber-based flame retardant has a lower limit that is preferably not less than 1 μm, more preferably not less than 2.5 μm, even more preferably not less than 4 μm, and particularly preferably not less than 5 μm. The average diameter of the fiber-based flame retardant has an upper limit that is preferably not more than 15.0 μm, more preferably not more than 12.5 μm, even more preferably not more than 10.0 μm, and particularly preferably not more than 8.0 μm. The aspect ratio has a lower limit that is preferably not less than 5, more preferably not less than 10, even more preferably not less than 15, and particularly preferably not less than 20. The aspect ratio has an upper limit that is preferably not more than 300, more preferably not more than 200, even more preferably not more than 125, particularly preferably not more than 80, and still more preferably not more than 40.

Examples of the fiber-based flame retardant include artificial mineral fiber and natural mineral fiber. Examples of the artificial mineral fiber include rock wool, stone wool, slug wool, mineral wool, glass wool, and mineral glass wool. Examples of the natural mineral fiber include wollastonite and potassium titanate fiber. Among these examples of the fiber-based flame retardant, artificial mineral fiber is preferable. Among the examples of the artificial mineral fiber, rock wool is preferable. In an embodiment, the fiber-based flame retardant is an inorganic substance. In an embodiment, the fiber-based flame retardant is not asbestos.

The silicone rubber layer may contain a component other than the components described above. Examples of such a component include a curing agent.

The curing agent is a component that imparts rubber elasticity to the silicone rubber layer. A person skilled in the art could select the curing agent as appropriate in accordance with a reaction mechanism for imparting rubber elasticity. Examples of the reaction mechanism carried out by the curing agent include a crosslinking reaction, a condensation reaction, and an addition reaction.

An organic peroxide can be used to impart rubber elasticity through the crosslinking reaction. Examples of the organic peroxide include benzoyl peroxide, 2,4-dichlorobenzoyl peroxide, dicumyl peroxide, cumyl-t-butyl peroxide, 2,5-dimethyl-2,5-di-t-butyl peroxyhexane, and di-t-butyl peroxide.

A silicon-containing crosslinking agent and a curing catalyst can be used to impart rubber elasticity through the condensation reaction. Examples of the silicone-containing crosslinking agent include alkoxysilanes, acetoxysilanes, and cyclic siloxanes. Examples of the curing catalyst include metal carboxylates and organotin compounds.

Organohydrogenpolysiloxane and a platinum-based catalyst can be used to impart rubber elasticity through the addition reaction. Organohydrogenpolysiloxane is polyorganosiloxane in which two or more hydrogen atoms per molecule on average are bonded to a silicone atom.

The silicone rubber layer may contain oil. Among oils, silicone oil is preferable, and modified silicone oil is more preferable. The silicone oil means oil that contains polyorganosiloxane as a main component. The modified silicone oil means silicone oil in which a methyl group contained in dimethyl silicone oil is partially substituted with another functional group. Examples of the modified silicone oil include amino-modified silicone oil, epoxy-modified silicone oil, carboxyl-modified silicone oil, carbinol-modified silicone oil, (meth)acrylic-modified silicone oil, mercapto-modified silicone oil, phenol-modified silicone oil, polyether-modified silicone oil, methylstyryl-modified silicone oil, alkyl-modified silicone oil, higher fatty acid ester-modified silicone oil, higher alkoxy-modified silicone oil, fluorine-modified silicone oil, and aralkyl-modified silicone oil. The modified silicone oil includes non-reactive modified silicone oil and reactive modified silicone oil. Among these modified silicone oils, non-reactive modified silicone oil is preferable.

The silicone rubber layer may contain various additives known in this technical field. Examples of such additives include: reinforcing fillers (such as silica, diatomaceous earth, quartz powder, mica, and titanium oxide); extending fillers (such as diatomaceous earth, quartz powder, mica, clay, glass beads, and aluminum oxide); heat resistance improvers (such as carbon black, rouge, alkali metal oxides, and alkaline earth metal oxides); and pigments.

A content of the flame retardant silicone rubber compound in the silicone rubber layer has a lower limit that is preferably not less than 50% by weight, and not less than 55% by weight, relative to a total weight of the silicone rubber layer. The content of the flame retardant silicone rubber compound in the silicone rubber layer has an upper limit that can be, for example, not more than 98% by weight.

A content of a silicone rubber polymer (polyorganosiloxane) in the silicone rubber layer has a lower limit that is preferably not less than 10% by weight, more preferably not less than 15% by weight, and even more preferably not less than 18% by weight, relative to the total weight of the silicone rubber layer. The content of the silicone rubber polymer in the silicone rubber layer has an upper limit that can be, for example, not more than 98% by weight.

In a case where the silicone rubber layer contains a rubber component(s) other than the silicone rubber, a ratio of the silicone rubber to a total of the rubber component(s) is preferably not less than 50% by weight, more preferably not less than 70% by weight, and even more preferably not less than 90% by weight. In an embodiment, the silicone rubber layer contains no rubber component other than the silicone rubber. Examples of the rubber component(s) other than the silicone rubber include fluorine rubber (FKM), natural rubber (NR), styrene-butadiene rubber (SBR), isoprene rubber (IR), butadiene rubber (BR), chloroprene rubber (CR), acrylonitrile-butadiene rubber (NBR), butyl rubber (IIR), ethylene-propylene rubber (EPM), ethylene-propylene-diene rubber (EPDM), urethane rubber (U), ethylene acrylic rubber (AEM), and acrylic rubber (ACM).

An amount of the fiber-based flame retardant contained in the silicone rubber layer has a lower limit that is preferably not less than 5 parts by weight, more preferably not less than 10 parts by weight, even more preferably not less than 15 parts by weight, and particularly preferably not less than 20 parts by weight, assuming that the flame retardant silicone rubber compound is contained in the silicone rubber layer in an amount of 100 parts by weight. In a case where the lower limit of the amount of the fiber-based flame retardant contained in the silicone rubber layer is in the above range, the silicone rubber layer tends to have sufficient flame retardancy. The amount of the fiber-based flame retardant contained in the silicone rubber layer has an upper limit that is preferably not more than 80 parts by weight, more preferably not more than 70 parts by weight, and even more preferably not more than 60 parts by weight, assuming that the flame retardant silicone rubber compound is contained in the silicone rubber layer in an amount of 100 parts by weight. In a case where the upper limit of the amount of the fiber-based flame retardant contained in the silicone rubber layer is in the above range, the silicone rubber layer tends to have softness suitable to serve as the insulating material. The fiber-based flame retardant is contained in an amount of, for example, preferably 5 parts by weight to 80 parts by weight, and more preferably 10 parts by weight to 80 parts by weight.

An amount of the oil contained in the silicone rubber layer has a lower limit that is preferably not less than 0.1% by weight, more preferably not less than 0.3% by weight, and even more preferably not less than 0.5% by weight, relative to the total weight of the silicone rubber layer. The oil that is contained in an amount of not less than 0.1% by weight improves processability. The amount of the oil contained in the silicone rubber layer has an upper limit that is preferably not more than 15% by weight, more preferably not more than 10% by weight, and even more preferably not more than 5% by weight, relative to the total weight of the silicone rubber layer. The oil that is contained in an amount of not more than 15% by weight makes it less likely for the silicone rubber layer to be excessively soft or for bleeding to occur.

An amount of other component(s) blended could be set, as appropriate, by a person skilled in the art in accordance with common general technical knowledge. For example, the curing agent can be contained in an amount of 0.2 parts by weight to 5.0 parts by weight assuming that the flame retardant silicone rubber compound is contained in an amount of 100 parts by weight.

[2. Insulating Material and Battery]

An insulating material in accordance with an embodiment of the present invention includes the laminate described earlier. The insulating material herein can be a molded product that is used while being interposed between a plurality of members. The plurality of members may be members whose relative position changes, or may be relatively stationary members.

A use of the insulating material is not particularly limited. The insulating material in accordance with an embodiment of the present invention has higher flame retardancy and makes it possible to maintain the insulating property even after burning. Thus, the insulating material in accordance with an embodiment of the present invention is preferably used in a product that is required to have flame retardancy and the insulating property. Examples of such a product include batteries, vehicles, residential building materials, household electrical appliances, and mobile terminals.

A laminate in accordance with an embodiment of the present invention is used for not only the insulating material but also any member that is required to have flame retardancy. For example, the laminate in accordance with an embodiment of the present invention may be used in a gasket that seals a space between two stationary members. The laminate may be used for a member that is required to have electroconducticity. In this case, the silicone rubber layer contains the fiber-based flame retardant that has both flame retardancy and electroconducticity.

The following description will discuss, with reference to FIG. 2, an example of use in the case of application of the insulating material in accordance with an embodiment of the present invention to a battery. A battery 100 includes insulating materials 11, cells 20, and a container 40. The battery 100 is configured to extract electric power from the cells 20 (12 cells 20 in FIG. 2). Note that FIG. 2 does not illustrate any member for extracting electric power from the cells 20. Specific examples of the battery 100 include a nonaqueous electrolyte secondary battery (such as a lithium ion secondary battery).

The insulating materials 11 are provided as separate plates for dividing an inside of the container 40. The insulating materials 11 can (i) prevent spread of fire even in a case where the cells 20 catch fire and (ii) maintain the insulating property even after burning. A cell 20 is a power generation element including a package of, for example, a positive electrode, a negative electrode, a separator, and an electrolyte. The container 40 is a member that stores therein the insulating materials 11 and the cells 20.

The inside of the container 40 is divided into a plurality of sections by the insulating materials 11. In FIG. 2, the inside of the container 40 is divided into four sections, which are a section A, a section B, a section C, and a section D. The cells 20 are separately provided in two or more of the plurality of sections. In FIG. 2, the cells 20 are provided in all the four sections A to D. Note, however, that there may be any section in which no cell 20 is provided.

For example, in a case where a cell 20 provided in the section A fails and catches fire, a corresponding insulating material 11 prevents spread of fire to the section B. The insulating material 11, which is an insulating material in accordance with an aspect of the present invention, has higher flame retardancy than a conventional insulating material and can maintain the insulating property even after burning. Thus, the battery 100 has higher safety than a conventional battery.

[3. Method for Producing Laminate]

A method for producing a laminate in accordance with an embodiment of the present invention includes: obtaining rubber coated metal by forming a layer of a rubber solution on a surface of a metal plate; drying the layer of the rubber solution; and carrying out hot pressing with respect to the rubber coated metal that has been dried. The rubber solution contains a flame retardant silicone rubber compound and a fiber-based flame retardant, and the flame retardant silicone rubber compound is rated as V-0 or higher according to UL94 standard. This makes it possible to obtain a laminate including a silicone rubber layer as described earlier.

[3.1 Step of Obtaining Rubber Coated Metal]

The rubber solution herein means a rubber solution obtained by dissolving or dispersing unvulcanized rubber in a solvent. Examples of the solvent for dissolving the unvulcanized rubber include: organic solvents such as toluene, methyl ethyl ketone (MEK), methyl isobutyl ketone (MIBK), xylene, ethylbenzene, isobutyl alcohol (IBA), ethylene glycol monoisopropyl ether, and ethylene glycol monobutyl ether; and a mixture of these organic solvents. Examples of a dispersion medium for dispersing the unvulcanized rubber include water. A solid content concentration in the rubber solution is ordinarily 10% by weight to 50% by weight. The rubber solution has a viscosity of preferably 50 mPa·s to 30000 mPa·s. Use of the rubber solution makes it possible to obtain a relatively thin silicone rubber layer.

The rubber solution is obtained by adding, to the solvent, the flame retardant silicone rubber compound and the fiber-based flame retardant, which are described earlier. It is preferable that the flame retardant silicone rubber compound and a curing agent be dissolved in the solvent and then a resulting solution be mixed with the fiber-based flame retardant added thereto. This enables a further reduction in load on equipment as compared with a case where a roller is used to mix the flame retardant silicone rubber compound with the fiber-based flame retardant.

The surface of the metal plate may be degreased before a layer of the rubber solution is formed. An adhesive may be applied to the surface of the metal plate, and baking may be further carried out.

A method of forming the layer of the rubber solution on the surface of the metal plate is not particularly limited. The metal plate may be immersed in the rubber solution, or the rubber solution may be applied to or sprayed on the metal plate. The method, which may be a roll coater method or a flow coater method, is preferably a method in which the metal plate is immersed in the rubber solution. It is particularly preferable to use a device and a method that are disclosed in Japanese Patent Application Publication Tokukai No. 2016-166644.

Specifically, a method in which an upper part of the metal plate is fastened with a clip and the clip is lowered to a rubber solution vessel containing the rubber solution is simple and preferable. The clip is lowered at a rate that is not particularly limited but is ordinarily 10 mm/second to 100 mm/second. Furthermore, it is preferable to bring two rods provided above the rubber solution vessel into close proximity to each other so as to set an interval between the two rods to a predetermined interval that is wider than a thickness of the metal plate. The interval (W (mm)) between the two rods and the thickness (t (mm)) of the metal plate preferably satisfy the following expression (1). In the following expression (1), (W−t) is preferably not less than 0.3 mm, and more preferably not more than 1.1 mm.

0.1<(W−t)<1.5 (1)

It is preferable that rubber coated metal in which the layer of the rubber solution is formed on both sides of the metal plate be obtained by leveling the surface of the layer of the rubber solution with use of the two rods while pulling up, through a space between the two rods, the metal plate which has been immersed in the rubber solution. The metal plate is pulled up at a rate that is not particularly limited but is ordinarily 10 mm/second to 100 mm/second.

[3.2. Step of Drying Layer of Rubber Solution]

A method of drying the layer of the rubber solution is not particularly limited but is preferably a method in which the layer of the rubber solution is dried while being fastened with the clip and hung. A drying temperature is ordinarily 15° C. to 70° C. Air or hot air can be blown onto the layer of the rubber solution. Alternatively, the layer of the rubber solution can be left to stand at room temperature for a predetermined time so as to be dried by natural drying.

[3.3. Step of Carrying Out Hot Pressing]

Hot pressing makes it possible to carry out vulcanization and ensure adhesion between the metal plate and the silicone rubber layer. The hot pressing is carried out at a heating temperature of preferably 150° C. to 230° C. The hot pressing is carried out at a heating temperature of more preferably not lower than 180° C., and even more preferably not lower than 190° C. Furthermore, the hot pressing is carried out at a heating temperature of more preferably not higher than 220° C., and even more preferably not higher than 210° C. A pressure is preferably 15 MPa to 25 MPa. Specifically, the hot pressing is carried out at a pressure of more preferably not less than 17 MPa, and even more preferably not less than 18 MPa. Moreover, the hot pressing is carried out at a pressure of more preferably not more than 23 MPa, and even more preferably 22 MPa.

A method of carrying out the hot pressing is not particularly limited, but may be a method in which the rubber coated metal that has been dried is sandwiched between heated plates. Note here that a thickness of a resulting laminate can be adjusted by providing a spacer around the rubber coated metal.

After carrying out the hot pressing, it is possible, if necessary, to further heat the resulting laminate so as to volatilize the remaining curing agent.

[4. Recapitulation]

An Embodiment of the Present Invention May Include features below.

<1>

A laminate including:
a metal plate; and
a silicone rubber layer provided on a surface of the metal plate,
the silicone rubber layer containing a flame retardant silicone rubber compound and a fiber-based flame retardant, and
the flame retardant silicone rubber compound being rated as V-0 or higher according to UL94 standard.

<2>

The laminate described in <1>, wherein the fiber-based flame retardant is contained in an amount of 10 parts by weight to 80 parts by weight assuming that the flame retardant silicone rubber compound is contained in the silicone rubber layer in an amount of 100 parts by weight.

<3>

The laminate described in <1> or <2>, wherein the fiber-based flame retardant contains at least one selected from the group consisting of artificial mineral fiber and natural mineral fiber.

<4>

The laminate described in <3>, wherein
the fiber-based flame retardant contains the artificial mineral fiber, and the artificial mineral fiber contains rock wool.

<5>

The laminate described in any one of <1> to <4>, wherein
a content of the flame retardant silicone rubber compound in the silicone rubber layer is not less than 50% by weight.

<6>

An insulating material including a laminate described in any one of <1> to <4>.

<7>

A battery including:
a plurality of cells;
an insulating material described in <6>; and
a container,
the plurality of cells and the insulating material each being stored in the container,
the insulating material being provided so as to divide an inside of the container into a plurality of sections, and the plurality of cells being separately provided in two or more of the plurality of sections.

<8>

A method for producing a laminate, including:
obtaining rubber coated metal by forming a layer of a rubber solution on a surface of a metal plate;
drying the layer of the rubber solution; and
carrying out hot pressing with respect to the rubber coated metal that has been dried,
the rubber solution containing a flame retardant silicone rubber compound and a fiber-based flame retardant, and
the flame retardant silicone rubber compound being rated as V-0 or higher according to UL94 standard.

<9>

The method described in <8>, wherein the hot pressing is carried out at a heating temperature of 150° C. to 230° C. and at a pressure of 15 MPa to 25 MPa.

<10>

The method described in <8> or <9>, wherein in the hot pressing, a thickness of a resulting laminate is adjusted by providing a spacer around the rubber coated metal.

### EXAMPLES

An embodiment of the present invention will be more specifically described below with use of Examples. Note, however, that the present invention is not limited to these Examples.

[Materials Used]
Flame retardant silicone rubber compound
Flame retardant silicone rubber compound (KE-5612E-U available from Shin-Etsu Chemical Co., Ltd., vinyl methyl silicone rubber-based compound, UL94 standard: V-0)
Flame retardant
Fiber-based flame retardant (RS490ELS-Roxul1000, Lapinus Fibres B.V., rock wool, fiber length: 150 μm to 250 μm)
Inorganic flame retardant (BF013 available from Nippon Light Metal Company, Ltd., particulate aluminum hydroxide)
Curing agent Curing agent (C-3 available from Shin-Etsu Chemical Co., Ltd., dicumyl peroxide)
Metal plate
Hot-dip aluminum-coated steel sheet (150 mm×100 mm×0.8 mm in thickness)
Adhesive
Adhesive/binder (SILASTIC™ DY 39-123 Primer available from Dow Toray Co., Ltd., mixture of vinyl trimethoxysilane and tetra n-butyl titanate)

[Device]

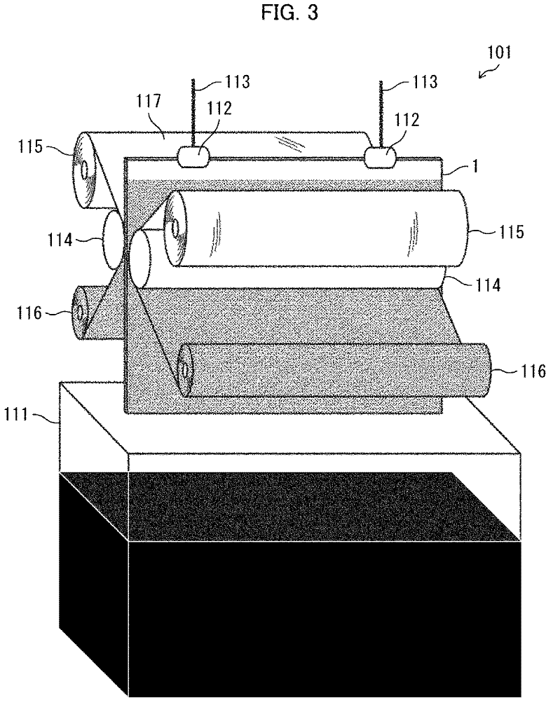

A device 101, illustrated in FIG. 3, for producing rubber coated metal was used to form a layer of a rubber solution on a surface of a metal plate 1. The metal plate 1 can be fastened with clips 112 provided at respective tips of arms 113. A rubber solution vessel 111 contains 50 L of the rubber solution. Two rods 114 are each a round bar having a diameter of 50 mm and made of polytetrafluoroethylene (PTFE). A protective film 117 wound around a wind-off roller 115 is a polyethylene film having a thickness of 50 μm. The protective film 117 can be wound up by a wind-up roller 116.

### Examples 1 to 3 and Comparative Examples 1 and 2

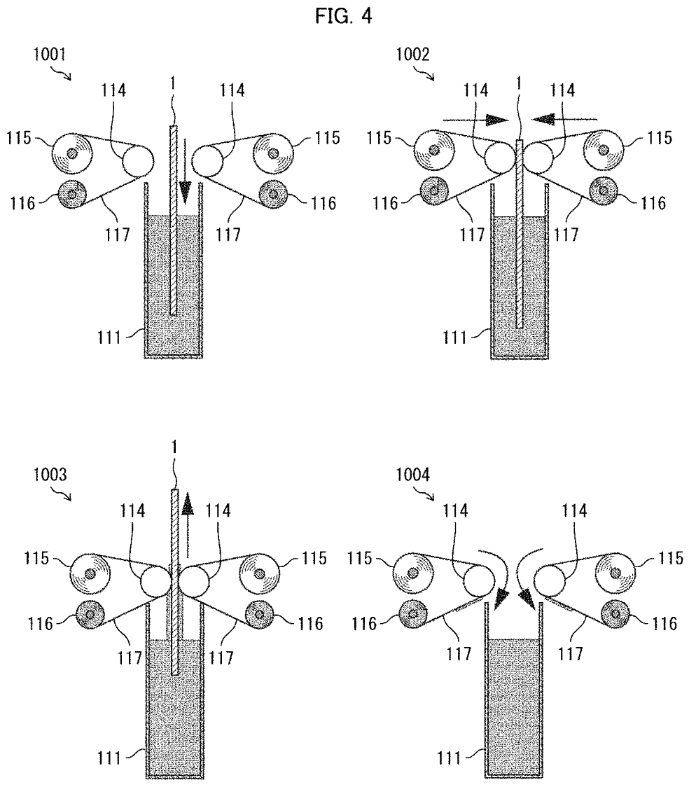

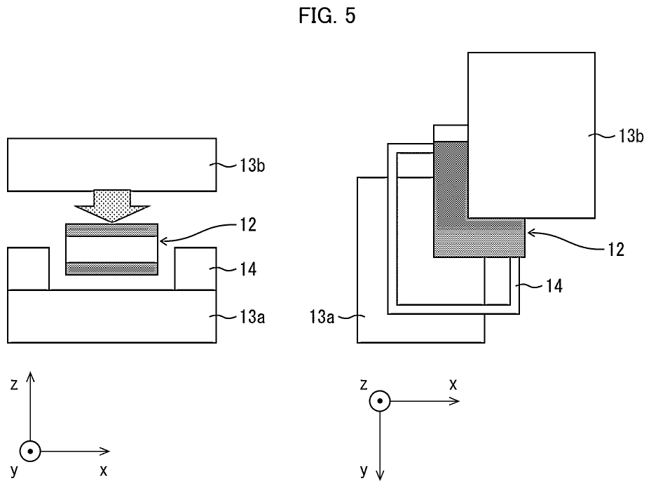

A laminate including a metal plate and a silicone rubber layer provided on both sides of the metal plate was produced in accordance with the following procedure. Note, however, that no flame retardant was used in Comparative Example 1.
1. A flame retardant silicone rubber compound and a curing agent were dissolved in toluene.
2. A rubber solution was obtained by pouring a flame retardant into a resulting solution and using a stirrer to mix a resulting mixture. A solid content concentration in the rubber solution was 40% by weight.
3. Acetone was used to degrease a metal plate.
4. An adhesive was applied to both sides of the degreased metal plate, and baking was carried out at 160° C. for 10 minutes.
5. A layer of the rubber solution was formed on both sides of the metal plate that had been subjected to baking. The following description uses FIG. 4 to describe the procedure.
(1) The metal plate 1 was fastened with the clips 112 (not illustrated in FIG. 4), and the clips 112 were lowered at a rate of 50 mm/second so that the metal plate 1 was immersed in the rubber solution contained in the rubber solution vessel 111 (a step 1001 in FIG. 4).
(2) The two rods 114 provided above the rubber solution vessel 111 were brought into close proximity to each other (a step 1002 in FIG. 4). In this case, an interval between the rods 114 was 1.85 mm.
(3) After one second had elapsed since immersion of the metal plate 1 in the rubber solution, the arms 113 (not illustrated in FIG. 4) were moved so that the clips 112 were raised at a rate of 50 mm/second. In so doing, the protective film 117 covering the rods 114 was used to level a surface of the layer of the rubber solution while pulling up the metal plate 1 through a space between the two rods 114 (a step 1003 in FIG. 4).
(4) The wind-up roller 116 was rotated so as to wind up the protective film 117 to which the rubber solution had adhered (a step 1004 in FIG. 4).
6. Thereafter, the metal plate 1 was naturally dried at room temperature while being fastened with the clips 112, and then the metal plate 1 was removed from the clips 112, so that rubber coated metal was obtained in which an unvulcanized rubber layer was formed on both sides of the metal plate 1.
7. Vulcanization and achievement of adhesion were carried out simultaneously by hot-pressing the obtained rubber coated metal. FIG. 5 is used to provide the following description. In FIG. 5, an x-axis and a y-axis are orthogonal to each other and parallel to a planar direction of rubber coated metal 12. A z-axis is perpendicular to the planar direction of the rubber coated metal 12 and shows a thickness direction. FIG. 5 provides (i) a view as seen from a y-axis direction and (ii) a view as seen from a z-axis direction. The rubber coated metal 12 was provided on a plate 13a heated to 200° C. and having a thickness of 1.2 mm. A spacer 14 having a thickness of 1.0 mm was provided around the rubber coated metal 12. A plate 13b heated to 200° C. and having a thickness of 1.2 mm was provided from above the rubber coated metal 12 and the spacer 14. Thus, pressure application was carried out at 20 MPa for 3 minutes.
8. In order to volatilize the remaining curing agent, the hot-pressed rubber coated metal was placed in an oven and heated at 180° C. for 1 hour. In this way, the laminate was obtained.

[Test Method]

The laminate produced as described above was used as a test piece to carry out a burning test. Flame of a burner was adjusted so that a temperature at a burning part was 850° C.±50° C. The flame was applied to one side of the test piece for 1 minute. A distance from a port of the burner to the test piece was set to 10 cm. After the burning test, an appearance of both sides of the test piece was visually checked. Furthermore, before and after the burning test, a resistance meter (RM3548 available from HIOKI E.E. CORPORATION) was used to measure a resistance value. An upper limit of a range of measurement of the resistance value was set to 3.5×10⁶Ω.

[Evaluation Result]

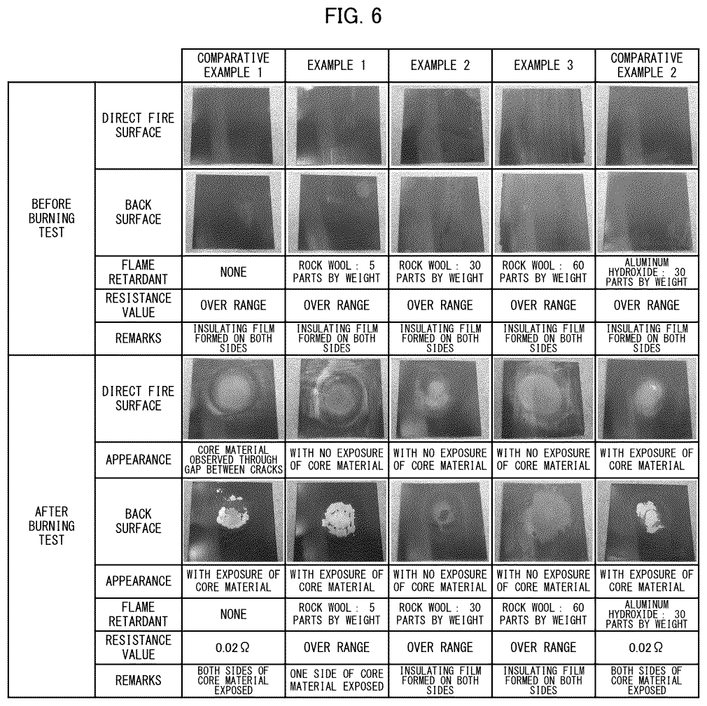

Table 1 shows compositions (part by weight) of the silicone rubber layers of Examples 1 to 3 and Comparative Examples 1 and 2. FIG. 6 shows an evaluation result. It has been confirmed that before the burning test, in all Examples 1 to 3 and Comparative Examples 1 and 2, the resistance value was over the range, that is, no electric current was passed through the test piece, and an insulating film was formed on both sides of the test piece.

TABLE 1

| | Flame | | | Inorganic |
|---|---|---|---|---|
| | retardant | | Fiber-based | flame |
| | silicone | | flame | retardant |
| | rubber | | retardant | (aluminum |
| | compound | Curing agent | (rock wool) | hydroxide) |
| Comparative | 100 | 1.3 | — | — |
| Example 1 | | | | |
| Example 1 | 100 | 1.3 | 5 | — |
| Example 2 | 100 | 1.3 | 30 | — |
| Example 3 | 100 | 1.3 | 60 | — |
| Comparative | 100 | 1.3 | — | 30 |
| Example 2 | | | | |

In FIG. 6, “DIRECT FIRE SURFACE” in “BEFORE BURNING TEST” means a surface to which flame has not been applied, and “DIRECT FIRE SURFACE” in “AFTER BURNING TEST” means a surface to which flame has been applied. Furthermore, “BACK SURFACE” means a surface on the back side of “DIRECT FIRE SURFACE”. After the burning test, in Comparative Example 1 containing no flame retardant and Comparative Example 2 containing aluminum hydroxide as the flame retardant, both sides of a core material (the metal plate) were exposed. In contrast, in Examples 1 to 3, at least one side of the core material was not exposed after the burning test. Thus, Examples 1 to 3 were superior in flame retardancy to Comparative Examples 1 and 2.

Furthermore, in Comparative Examples 1 and 2, the resistance value was small after burning, and an electric current was passed through the test piece. In contrast, in Examples 1 to 3, no electric current was passed through the test piece even after burning, and an insulating property of the test piece was maintained. Thus, it has been found that Examples 1 to 3 have higher flame retardancy than Comparative Examples 1 and 2 and that Examples 1 to 3 can maintain the insulating property even after burning. Example 2, in which rock wool was added, was superior in flame retardancy and insulating property to Comparative Example 2, in which aluminum hydroxide was added in the same amount as the amount of the rock wool added in Example 2. Examples 2 and 3 were superior in flame retardancy to Example 1.

### INDUSTRIAL APPLICABILITY

An aspect of the present invention can be used for an insulating material of, for example, a battery.

### REFERENCE SIGNS LIST

1 Metal plate
2a, 2b Silicone rubber layer
10 Laminate
11 Insulating material
20 Cell
40 Container
100 Battery

1. A laminate comprising:
a metal plate; and
a silicone rubber layer provided on a surface of the metal plate,
the silicone rubber layer containing a flame retardant silicone rubber compound and a fiber-based flame retardant, and
the flame retardant silicone rubber compound being rated as V-0 or higher according to UL94 standard.

2. The laminate as set forth in claim 1, wherein the fiber-based flame retardant is contained in an amount of 10 parts by weight to 80 parts by weight assuming that the flame retardant silicone rubber compound is contained in the silicone rubber layer in an amount of 100 parts by weight.

3. The laminate as set forth in claim 1, wherein the fiber-based flame retardant contains at least one selected from the group consisting of artificial mineral fiber and natural mineral fiber.

4. The laminate as set forth in claim 3, wherein
the fiber-based flame retardant contains the artificial mineral fiber, and
the artificial mineral fiber contains rock wool.

5. The laminate as set forth in claim 1, wherein a content of the flame retardant silicone rubber compound in the silicone rubber layer is not less than 50% by weight.

6. An insulating material comprising a laminate recited in claim 1.

7. A battery comprising:
a plurality of cells;
an insulating material recited in claim 6; and
a container,
the plurality of cells and the insulating material each being stored in the container,
the insulating material being provided so as to divide an inside of the container into a plurality of sections, and
the plurality of cells being separately provided in two or more of the plurality of sections.

8. A method for producing a laminate, comprising:
obtaining rubber coated metal by forming a layer of a rubber solution on a surface of a metal plate;
drying the layer of the rubber solution; and
carrying out hot pressing with respect to the rubber coated metal that has been dried,
the rubber solution containing a flame retardant silicone rubber compound and a fiber-based flame retardant, and
the flame retardant silicone rubber compound being rated as V-0 or higher according to UL94 standard.

9. The method as set forth in claim 8, wherein the hot pressing is carried out at a heating temperature of 150° C. to 230° C. and at a pressure of 15 MPa to 25 MPa.

10. The method as set forth in claim 8, wherein in the hot pressing, a thickness of a resulting laminate is adjusted by providing a spacer around the rubber coated metal.

11. The laminate as set forth in claim 2, wherein the fiber-based flame retardant contains at least one selected from the group consisting of artificial mineral fiber and natural mineral fiber.

12. The laminate as set forth in claim 11, wherein
the fiber-based flame retardant contains the artificial mineral fiber, and
the artificial mineral fiber contains rock wool.
